(19) United States
(12) Patent Application Publication
(10) Pub. No.: US 2021/0082078 A1
(43) Pub. Date: Mar. 18, 2021

(54) THE SYSTEM AND METHOD OF OPERATING THE SELF-STEERING ELECTRIC TAXI AND SMART UNDERGROUND PARKING LOTS

(71) Applicant: Cuong Manh VU, Ho Chi Minh (VN)

(72) Inventor: Cuong Manh VU, Ho Chi Minh (VN)

(21) Appl. No.: 16/759,447

(22) PCT Filed: Oct. 29, 2018
(86) PCT No.: PCT/IB2018/058423

§ 371 Date: Sep. 17, 2020

(30) Foreign Application Priority Data
Oct. 30, 2017 (VN) 1-2017-04318

(51) Int. Cl. G06Q 50/30; G06Q 10/02; G06Q 10/06; G06Q 10/00; G06Q 30/02; G06Q 50/14; G06Q 30/06; G06Q 20/08; G07B 15/00; G05D 1/02; G05D 1/00; G08G 1/00; H04M 1/7243

(52) U.S. Cl. CPC G06Q 50/30; G06F 8/61; G06Q 10/06315; G06Q 10/20; G06Q 30/0284; G06Q 50/14; G06Q 30/0627; G06Q 20/085; G07B 15/00; G05D 1/0297; G05D 1/0088; G08G 1/207; G08G 1/202; H04M 1/7243; G06Q 2240/00; G06Q 10/02

(57) ABSTRACT

The present invention relates to a system and method of operating the self-steering electric taxi and smart underground parking lots (SCP-S) 100, the system comprises a fleet of electric and/or smart vehicles of all types (SEC) 10, a network of smart underground parking lots (SPN) 20, a multi-line real-time operating center (ROC) 30, and a vehicle booking application 40, all interacts with each other via an wire- and/or wireless-connected protocol/network 50. And a method of operating this system, comprises receiving a request (Step 1), preparing available vehicles (Sub-step 2a, 2b, and 2c), or announcing the waiting status (Step 3), processing until the vehicle is ready (Step 4), providing vehicle information (Step 5), accepting booking (Step 6), dispatching vehicle (Step 7), and taking back vehicle (Step 8).

### TECHNICAL FIELD

The present invention generally relates to the taxi services for passenger and delivery, more particularly relates to a system and method of operating the self-steering electric taxi and smart underground parking lots.

### BACKGROUND OF THE INVENTION

Electric vehicles have been used for transportation and recreational purposes in many parts of the world, there are popular passenger electric cars of from 4 to 7 seats, buses ranging from 6 to 16 seats, often used in city centers and resorts, and small vehicles with 1 to 3 seats. Electric vehicles are highly recommended for use as a replacement for traditional ones (using gasoline/petrol), especially in cities. However, the disadvantage of electric vehicles is the limited power supply capacity of batteries, storage cells, and the infrastructure for electric vehicles has not yet developed. For example, the battery charging stations and maintenance garages to provide services to electric vehicle users are limited.

Smart parking lots (undergrounded or on-ground) have been used in large/crowded cities with many high-rise buildings recently. The small size one contains from 12 to 16 cars on its space of equivalent to 2 cars and the larger size one can contain hundreds of cars. Especially, the smart undergrounded bicycle parking system—Eco Cycle in Japan that just occupies a tiny ground area but can contain up to hundreds of bikes inside. And the processes of putting bicycles into the parking lot or bringing them out take only for a short time. In general, the systems mentioned above are not applicable to small electric vehicles that have less than 4 seats.

The system of operation and management of parking lots using information technology has also been applied by traffic authorities in many cities. Such systems operate based on the management of parking lots in the controlled area, can monitor the availability of parking ones and empty-slots by using sensors, which allocated in the vicinity of parking spaces for vehicle detection and surveillance. Availability information on parking also can be displayed and disseminated via the Internet that allows drivers to obtain parking information before or during the trip, and to reserve a parking lot via phone or the Internet; and Bluetooth technology can recognize each vehicle at entry points, which can trigger automatic reservation checking and parking payment. In addition, the patent no. US2014149153 also introduces a method and system that allows assigning and reserving an optimal resource of parking space for a discrete user based on the user's objective function that combines proximity to destination with parking cost in real-time, while also ensuring that the overall parking capacity is efficiently utilized. The systems mentioned above have not been developed and applied to taxi service.

The advantages of the invention disclosed herein are that it can: completely reduce traffic congestions and roadblocks; absolutely eliminate air pollution from petrol/gasoline vehicles; reduce most of the cost of buying and investing in private vehicles; and significantly increase the space and area of public buildings such as parks, roads and squares to increase the quality of life of people in cities.

### SUMMARY OF THE INVENTION

A system and method of operating self-steering electric taxi and smart underground parking lots disclosed herein, the system comprising a fleet of small electric and/or smart vehicles with two to four seats (includes driver's seat), and electric/smart vehicles for people with disabilities; a network of at least two smart/automatic underground parking lots that are structured and installed underground, such as of the sidewalks/roadsides, streets or intersections; and an operating system/platform that allows displaying the network of underground parking lots in the certain area and the distances between a defined user and each certain actual underground parking lot on the user interface, which screening detailed information such as of the number and type of electric/smart vehicle available, distance, accessibility, the remaining power capacity and the estimated kilometer can afford, then the options of booking/picking-up.

In one simplest embodiment disclosed herein, the present invention refers to small three-wheel electric vehicles (in which a single wheel is structured in the front or rear) or four-wheel, whose steering system that is designed similarly to the cars and motorcycles' ones.

In other embodiments, all electric/smart vehicles are equipped with global positioning system (GPS), sensors, wireless network connected computers, and self-driving software or autonomous-driving program.

A basic smart/automatic underground parking lot comprises at least a parking-floor that can containing dozens of parking slots equipped with the autonomous built-in chargers for all electric/smart vehicle types (from two to four seats); at least an operating-room; a maintenance and repair garage; and a room for automatic washing, vacuuming, and deodorizing vehicles.

The method of operating self-steering electric taxi starts working by the user's vehicle booking requests, which launching an application/app installed on personal smart devices; and/or the user can directly manipulate on the built-in interactive screens with the ground station of underground parking lot by smart/credit card; then the application will present a sufficient/detailed information on the number and type of electric/smart vehicle available, on each one's distance, accessibility, the remaining power capacity, and the estimated kilometer can pass for the user to select/decide.

In other embodiments, a user's booking request may also be made via an automated telephone and/or short message service (SMS) gateway/switchboard; and the requestor will receive the feedbacks by voice and/or text messages.

Next, the user selects the vehicle type, determines the destination and/or estimated time amount of service usage. The application/app will provide detailed information about the selected vehicle, the itinerary, the expected travel time, and the calculated fee based on the total time and/or distance using vehicle.

When the user accepts payment (or can be changed to another vehicle option or cancel order), the system of the nearest or designated smart underground parking lot will bring up the booked vehicle on the ground. Each booked vehicle has an electronic identification number that displays on the hood or body of the vehicle and simultaneously releases voice and displays on the user interface devices.

In other embodiments, the selected smart electric vehicle can autonomous-drive to the pick-up location and then also autonomous-drive passengers and/or commodities to the defined destination according to the route displaying on the electronic map.

The suggested vehicle list is defined based on the analysis of the information of requestor, the available vehicles in the underground parking lots and real-time ones that working on ground to optimize the combination of the requestor's objective with the whole system.

In the process of the vehicle's journey to the destination, in both cases of the user take self-driving and autonomous-driving, the built-in computer will automatically update the traffic density and other unusual circumstances to let the user or vehicle deciding to change to a better route.

Once the vehicle reaches the destination or finish the journey, the payment is automatically calculated and deducted directly on the smart and/or credit card account that was used for initial register/activation, then the vehicle's door opens and electronic identification number stops displaying.

In the case of the vehicle carrying/delivering commodities (autonomous-driving vehicle), the consignee at the destination will use the secret code (or OTP-One Time Password) that was provided by the requestor to open the vehicle's door instead of using the smart and/or credit card that was used for initial register/activation.

### BRIEF DESCRIPTION OF THE DRAWINGS

The preferred embodiment of invention is illustrated herein, the above-mentioned signs, features, and advantages in conjunction with the operation of the invention may be better understood by reference to a more particular description in accompanying drawings, in which:

FIG. 1

FIG. 1 shows a block diagram of a model of “the system and method of operating the self-steering electric taxi and smart underground parking lots” illustrating an embodiment of the present invention;

FIG. 2

FIG. 2 shows a flow diagram of a method of operating “the system and method of operating the self-steering electric taxi and smart underground parking lots” in accordance with the present invention.

### DETAILED DESCRIPTION OF THE PREFERRED EMBODIMENTS

The present invention in according with the drawings and briefly described above is described in more detail with function in this section. However, the present invention may be embodied and understood in other ways than that is limited to the drawings in the description. In particular, the system and methods can be adjusted in terms of layout, arrangement, configuration, components, structure, size, process, etc. to reveal and use in a specific way.

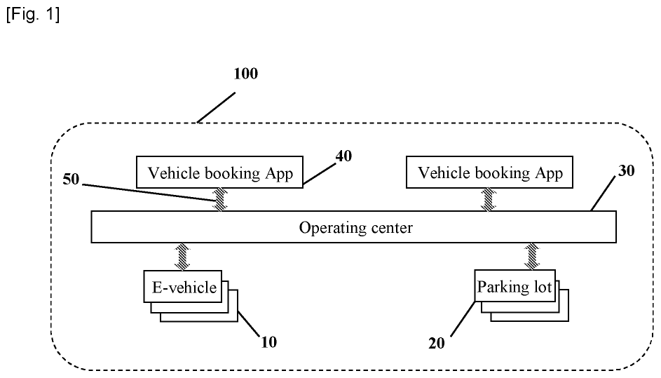

The system and method of operating the self-steering electric taxi and smart underground parking lots herein is presented and described in more detail referring to FIG. 1.

As shown in FIG. 1, in one specific embodiment of the invention of the system and method of operating the self-steering electric taxi and smart underground parking lots (SCP-S) 100, the system can include a fleet of electric and/or smart vehicles of all types (SEC) 10, a network of at least two smart/automatic underground parking lots (SPN) 20, a multi-line real-time operating center (ROC) 30, and a vehicle booking application 40 for installing on the smart personal devices (for example: smartphones, tablets, etc.). The whole system mentioned above interacts with each other via at least one of an wire- and/or wireless-connected protocol/network 50 (for example: via copper, fiber, satellite, radio, telephone, short message service (SMS), short distance wireless technology (Bluetooth), general packet radio services (GPRS), the generations of broadband cellular network technology (2G, 3G, 4G), world wide web (Internet), wide area networks (WAN), local area network (LAN), wireless network (Wi-Fi), etc.)

SEC 10 can include a type of two-seats electric vehicles (including the driver's seat), a type of three-seats electric vehicles (including the driver's seat), a type of four-seats electric vehicles (including the driver's seat), and a type of electric vehicles for people with disabilities. Each vehicle is equipped with a network connected computer to operate the autonomous-driving control program, and a control panel integrated touch screen.

SPN 20 basically includes a kind of small size parking lots that can contain 120 electric vehicles of all types and basic functional areas, a kind of medium size parking lots that can contain from 120 to 360 electric vehicles of all types and full-functional areas, and a kind of large size parking lots that can contain from 360 to thousands electric vehicles of all types and all advanced functional, and extra areas. Each parking lot can include at least a underground multi-parking floors, an area for automatic washing, vacuuming, and deodorizing vehicles, a maintenance and repair garage, an operating-room equipped with network connected computers that operate the vehicle resource management and allocation program, a temporary vehicle waiting area/station with roof, an electronic board that displays the vehicle status information, an interactive screen with user interface for interacting, and a manipulate panel with buttons for selecting vehicles.

ROC 30 has the functions of collecting, storing, and processing the book requests from requestors, tracking in real-time the geographical positional data of all requestor and the SEC 10 vehicles that are on the ground, centrally managing the vehicle resources of SPN 20, and providing data and vehicle dispatching information for displaying on the user interface. Accordingly, ROC 30 can include at least a physical server; a cloud/virtual server; vehicle requestor database; a parking lot database; a vehicle database, all for operating an operating system; and an automated telephone and/or message switchboard.

Although various embodiments of the present invention have been illustrated, however, the general principles and spirit of the invention may be applied to other illustrative examples that are the significant difference compared to the specific embodiments presented.

In order to optimization the system that based on the random databases of all request in terms of time, geographic location, number and type of vehicle, length of time using vehicle, and other occurrences, SCP-S 100 can operate automatically and continuously to meet the rapidly changing status of the resource and database systems until the requestor successfully books the most desired vehicle and receives it within a shortest waiting time. At each certain circumstance, the system also offers the requestor/user with optimal alternative options of vehicles or routes.

SCP-S 100 can quickly and accurately analyze the requests and its intrinsic requirements in real-time interaction with SEC 10 and SPN 20. Accordingly, the system and method can at the same time allocating as many vehicles as possible for the largest number of requestors with the purpose of minimizing the total vehicle waiting/getting time and the total time vehicle on the road. Therefore, the process of providing and offering a self-steering vehicle is a sequence of algorithms that addressing in real-time in a specific context of the entire SCP-S 100 system.

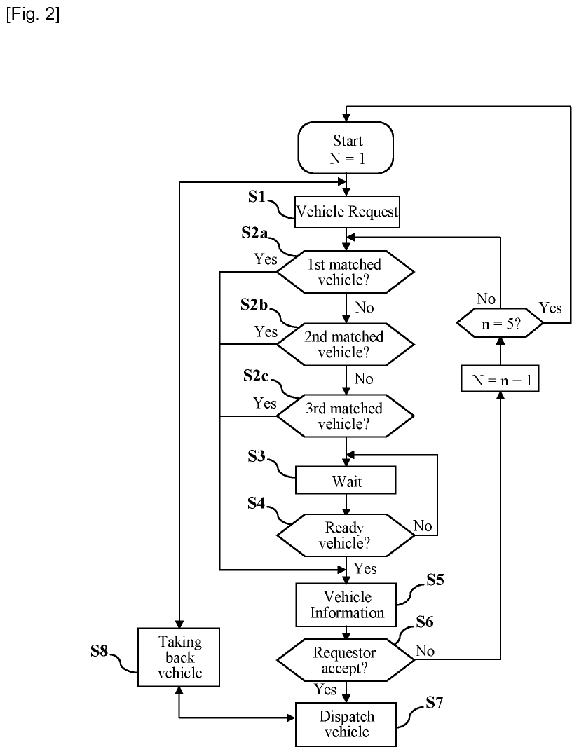

The method of operating the self-steering electric taxi and smart underground parking lots herein is presented and described in more detail referring to FIG. 2.

FIG. 2 illustrates a flow diagram that meets the request for an electric taxi via using the SCP-S 100 system described above. Accordingly, the method of operating the self-steering electric taxi and smart underground parking lots taxi be started by receiving a vehicle booking request from a requestor (step 1), preparing various available vehicles and options (sub-step 2a, 2b, and 2c), or

announcing the waiting status (step 3), and continuously processing to seek and list at least one available vehicle can satisfy the requestor's requirements (step 4), providing detailed information about the selected vehicle, itinerary, estimated travel time, and the calculated fee based on the total time and/or distance using vehicle (step 5), accepting the booking and payment from requestor (step 6), dispatching the booked vehicle to the departure area and/or pick-up location (step 7), and receiving the vehicle when the user return it and/or the journey is over (step 8).

According to step 1, in an implementation, the requestor can make a request by activating the vehicle booking application 40 on a personal smart device that is connected by an wire- and/or wireless-network (in an usual example herein is the Internet); or activating by a smart and/or credit card then interacting directly on the interactive screen (in an usual example herein is the touch screen) or manipulate panel with buttons for selecting vehicles of the nearest parking lot (normally at intersections); or making via the automated telephone and/or message switchboards and the requestor will receive the feedbacks by voice and/or text messages; and making the specific requirements for vehicle type, destination and/or the total time using vehicle.

According to (step 2), in an implementation, ROC 30 continuously updating the real-time geographical positional database of all SEC 10 vehicles on the ground and the available vehicle resource database of the surrounding SPN 20 parking lots in order offering immediately one by one available prioritized vehicle (sub-step 2a, 2b, and 2c)—in a strategy of those ones that are better matched with the requestor's requirements will go first (an example herein is the level of time and cost)—on the user interface with sufficient information on the number, type of vehicle available, and distance traveled for the requestor selecting.

In another implementation, (step 2) can be prioritized operated by the vehicle resource management and allocation program of a specific SPN 20 parking lot when interacting directly with the requestor on the interactive screen and/or manipulate panel.

In another implementation, (step 2) can also be performed via the automated telephone and/or message switchboards after the requestor verifying the temporary service code (an example herein is a code that was sent by telephone and/or message switchboards to the requestor's registered phone number).

According to (step 3), in an implementation, ROC 30 may moving the requestor to a temporary waiting state (an example herein is a maximum of two waiting minutes) and informing on the user interface or the interactive screen or via the message service, at the same time, constantly updating the vehicle resource database until at least one vehicle is available (step 4) for the requestor selecting.

According to (step 4), in an implementation, ROC 30 can offering one by one available vehicle (sub-step 2c, 2b, and 2a)—in a strategy of those ones that are better matched with the requestor's requirements will go last (an example herein is the level of time and cost)—on the user interface or the interactive screen or via the message service for the requestor selecting.

This step can be repeated in many times until ROC 30 receiving a vehicle selection from the requestor.

According to (step 5), in an implementation, ROC 30 can providing detailed information (an example herein is the identification number, destination, itinerary, estimated travel time, dispatching time, and the total estimated fee and/or distance using vehicle) of a specific vehicle that was selected by the requestor through one of step (sub-step 2a, 2b, 2c), and (Step 4) on the user interface or the interactive screen or via the message service for the requestor determining.

According to (step 6), in an implementation, ROC 30 receiving, processing the vehicle booking request, and automatically charging the payment (on the smart and/or credit card account) from the requestor, and preparing to dispatch the booked vehicle (step 7).

In another implementation, (step 6) can be prioritized operated by the vehicle resource management and allocation program of a specific SPN 20 parking lot when interacting directly with the requestor on the interactive screen and/or manipulate panel. The total estimated fee (including the fees of booking and using vehicle) can be paid one time in coins or banknotes by putting it inside the manipulate panel of the parking lot, then a vehicle booking card will be printed out for the requestor.

In another implementation, (step 6) can also be performed via the automated telephone and/or message switchboards and the requestor will receive a vehicle booking number that was sent to the requestor's registered phone number.

In the case that (step 6) is rejected by the requestor, ROC 30 can repeat the process from (step 1) in many times until ROC 30 receiving an acceptation of payment from the requestor. However, if after a certain number of times (an example for the purposes of illustration herein is only five times), the requestor still has not accepted to pay, ROC 30 may encourage the requestor restarting with another request, or temporarily logging out the application 40.

According to (step 7), in an implementation, ROC 30 can demanding one of the nearest SPN 20 parking lots to the user's location to dispatch the booked vehicle to the departure area and/or pick-up location. Each booked vehicle will have an electronic identification number that displays on the hood or body and simultaneously releases the voice and displays on the user interface or the interactive screen or via the message service.

In another implementation, the booked vehicle can also autonomous-drive to the pick-up location and then again autonomous-driving passengers and/or commodities to the defined destination according to the planned route.

In order to meet all vehicle booking request with the fastest execution time of (step 7), SCP-S 100 automatically and continuously performs the algorithms so that the requestors can successfully book the most desired vehicle and receive it within a shortest waiting time (an example herein is the maximum of one minute at the SPN 20 parking lot and nine minutes in the case of a distance booking).

According to (step 8), in an implementation, ROC 30 can recording the dispatched vehicle's journey to the destination (in both cases, the user self-driving and autonomous-driving/carrying commodities), estimating the distance and total time to reach the destination or finish the journey, and preparing to assign one of the nearest SPN 20 parking lots to the destination in order to take back the vehicle when the user return it and/or the journey is over.

In another implementation, once the vehicle reaching the destination or finishing the journey, the total fee is automatically resumed and deducted directly on the smart and/or credit card account that was used for initial register/activation, then the vehicle's door opens and electronic identification number stops displaying.

In another implementation in the case of the booked vehicle for carrying/delivering commodities, the consignee at the destination will use the secret code (that was provided by the requestor) to open the vehicle's door instead of using the smart and/or credit card that was used for initial register/activation.

As described above, the implementation of a booking request via “the system and method of operating the self-steering electric taxi and smart underground parking lots”, is based on three main characteristics of the vehicle type, the locations of vehicle and parking lots, and the route. In which, the vehicle specifications require the SCP-S 100 must carrying a vehicle specific booking/retention request so that to ensure the requestor, who is waiting at the SPN 20 parking lot or remotely, can successfully booking. An example of a vehicle specification that has been booked/reserved for a designated user, can include a vehicle's electric identification number (such as a traditional taxi number); an automated door lock that can only be opened by the smart and/or credit cards or booking card, or secret code.

In another set of characteristics of electric identification number that contains more information, may include, for example, the green light is informing the vehicles that are in the early stage of the route; the yellow light is showing the ones at the end stage of the route; and the red light meaning that the vehicles are at the end of the route and entering one of the nearest SPN 20 parking lots. Once the journey is over, the electronic identification number stops displaying.

The modifications in the details, parts, and layout of the components in the SCP-S 100 system and the steps of the operating method described and illustrated herein may be carried out by those skilled in the field with reference to the above detailed instructions. Accordingly, the following claims shall be construed as not being limited to the above presented embodiments and may include other embodiments that are specifically described and explained as broadly as are provided for permission within the framework of the law.

1. A system of operating the self-steering electric taxi and smart underground parking lots in order to at the same time optimally allocating as many vehicles as possible for the largest number of requestors based on their specific requirements with the purpose of minimizing the total vehicle waiting/getting time and the total time vehicle on the road, the system comprising:
a fleet of electric and/or smart vehicles;
a network of smart underground parking lots;
a multi-line real-time operating center;
a vehicle booking application or app; and
a wire- and/or wireless-connected protocol/network of copper, fiber, satellite, radio, telephone, short message service (SMS), Bluetooth wireless technology, general packet radio services (GPRS), the generations of broadband cellular network technology (2G, 3G, 4G), Internet, wide area networks (WAN), local area network (LAN), and wireless network (Wi-Fi).

2. The system of claim 1, wherein the fleet of electric and/or smart vehicles includes at least one of: a type of two-seats vehicles (including the driver's seat); a type of three-seats vehicles (including the driver's seat); a type of four-seats vehicles (including the driver's seat); and a type of two-seats vehicles (including the driver's seat) for people with disabilities.

3. The system of claims 1 and 2, wherein each vehicle includes at least one of: a computer that is connected with the network; an autonomous-driving program; and a control panel integrated touch screen.

4. The system of claim 1, wherein the network of smart underground parking lots includes at least one of: a kind of small size parking lots that can contain electric vehicles of all kinds and basic functional areas; a kind of medium size parking lots that can contain electric vehicles of all types and full-functional areas; and a kind of large size parking lots that can contain electric vehicles of all types and all advanced functional and extra areas.

5. The system of claims 1 and 4, wherein each smart parking lot comprises at least a parking-floor; an area for automatic washing, vacuuming, and deodorizing vehicles; a maintenance and repair garage; an operating-room equipped with network connected computers; a vehicle resource management and allocation program; a temporary vehicle waiting area/station with roof; an electronic board with interactive screen; and a manipulate panel.

6. The system of claims 1, 4, and 5, wherein the parking-floor further comprising multi-floors, each one includes multi-parking slots with built-in auto-chargers.

7. The system of claims 1, 4, 5, and 6, wherein each smart parking lot further comprising an autonomous double conveyor belt for receiving vehicles arriving and moving already arrived vehicles to the down-lift module that connected with underground parking floors; and an autonomous double conveyor belt for dispatching booked vehicles from the up-lift module that connected with parking floors to the departure area or pick-up location.

8. The system of claim 1, wherein the multi-line real-time operating center comprises at least a physical server; a cloud/virtual server; a vehicle requestor database; a parking lot database; a vehicle database; an operating system; and an automated telephone and/or message switchboard.

9. The system of claims 1, 2, 4, and 8, wherein the multi-line real-time operating center interacts with electric/smart vehicles and smart underground parking lots via at least one of an wire- and/or wireless-connected protocol/network of copper, fiber, satellite, radio, telephone, short message service (SMS), Bluetooth wireless technology, general packet radio services (GPRS), the generations of broadband cellular network technology (2G, 3G, 4G), Internet, wide area networks (WAN), local area network (LAN), and wireless network (Wi-Fi).

10. The system of claim 1, wherein the vehicle booking application or app comprises at least a software version for installing and operating on the smart personal devices, smartphones, tablets, and network connected personal computer.

11. The method of operating the self-steering electric taxi and smart underground parking lots in order to at the same time optimally allocating as many vehicles as possible for the largest number of requestors based on their specific requirements with the purpose of minimizing the total vehicle waiting/getting time and the total time vehicle on the road, the method comprising:
receiving a request for vehicle;
preparing various available vehicles and options; or
announcing the waiting status; and
continuously processing to seek and list at least one available vehicle can satisfy the requestor's requirements;
providing detailed information about the selected vehicle, itinerary, estimated travel time, and the calculated fee based on the total time and/or distance using vehicle;
accepting the booking and payment from requestor;
dispatching the booked vehicle to the departure area and/or pick-up location; and
receiving the vehicle when the user returns it and/or the journey is over.

12. The method of claim 11, wherein receiving a request for vehicle further comprising: activating the vehicle booking application or app by the requestor on personal smart devices; or interacting directly on the interactive screen or manipulate panel of the parking lot; or making via the automated telephone and/or message switchboards; and storing the specific requirements for vehicle type, destination and/or the total time using vehicle.

13. The method of claim 11, further comprising: updating the real-time geographical positional database of electric/smart vehicles on the ground and the available vehicle resource database of the surrounding parking lots; and offering one by one available prioritized vehicle that is the most matched with the requestor's requirements on the user interface with sufficient information on the number, type of vehicle available and distance traveled.

14. The method of claims 11 and 13, further comprising: offering one by one available prioritized vehicle that is the most matched with the requestor's requirements on the interactive screen and manipulate panel of the parking lot.

15. The method of claims 11 and 13, further comprising: offering one by one available prioritized vehicle that is the most matched with the requestor's requirements via the automated telephone and/or message switchboards, and sending messages to the requestor's phone.

16. The method of claim 11, further comprising: informing the requestor a temporary waiting state; and at the same time, constantly updating the vehicle resources until at least one vehicle available.

17. The method of claim 11, wherein processing to seek and list at least one available vehicle can satisfy the requestor's requirements further comprising offering continuously one by one new available vehicle for the requestor selecting.

18. The method of claims 11 and 17, further comprising: updating the databases continuously; and offering substitute vehicles repeatedly until a vehicle is selected by the requestor.

19. The method of claim 11, further comprising: receiving the requestor confirmation for a selected vehicle; and providing the all detailed information of selected vehicle for the requestor to determine.

20. The method of claim 11, wherein accepting the booking and payment from requestor further comprising: receiving, processing the vehicle booking request; and automatically charging the payment.

21. The method of claims 11 and 20, further comprising: directly receiving the vehicle booking request on the interactive screen and/or manipulate panel of the parking lot; charging the fees of booking and using vehicle in coins or banknotes; and printing a booking card to the requestor.

22. The method of claims 11 and 20, further comprising: receiving the vehicle booking request via the automated telephone and/or message switchboards; and sending a booking number to the requestor's registered phone number.

23. The method of claims 11 and 20, further comprising: receiving the requestor's cancellation; continuously repeating the booking flow until a payment is done by the requestor; and/or announcing the requestor to start again with different requirements or temporarily log out the app.

24. The method of claim 11, wherein dispatching the booked vehicle to the departure area and/or pick-up location further comprising: assigning an underground parking lot to dispatch the booked vehicle for the requestor.

25. The method of claims 11 and 24, further comprising: imposing an identification number for the booked vehicle; and at the same time, informing to the requestor.

26. The method of claims 11, 24, and 25, further comprising: informing the identification number on the user interface or the interactive screen or via the message service.

27. The method of claims 11 and 24, further comprising: dispatching the booked vehicle to autonomous-drive to the pick-up location; opening the vehicle's door and turning off the electronic identification number when the user scanning/putting the cards in; and then autonomous-drive carrying passengers and/or commodities to the defined destinations according to the planned route.

28. The method of claim 11, wherein dispatching the booked vehicle to the departure area and/or pick-up location further comprising: recording the dispatched vehicle's journey to the destination in both cases, the user self-driving and autonomous-driving; estimating the distance and total time to reach the destination or finish the journey; preparing to assign a parking lot for taking back the vehicle; and automatically updating the traffic density and other unusual circumstances to let the user or vehicle deciding to change to a better route.

29. The method of claims 11 and 28, further comprising: calculating the actual fee when the vehicle reaches the destination or the journey is over; and directly deducting on the requestor's credit card or smartphone card account.

30. The method of claims 11, 28, and 29, further comprising: opening the vehicle's door at the destination when the consignee using the secret code instead of smart and/or credit card in order to receive commodities inside.
